(19) United States
(12) Patent Application Publication
(10) Pub. No.: US 2014/0108320 A1
(43) Pub. Date: Apr. 17, 2014

(54) PREFERENCE PREDICTION TOOL

(71) Applicants: Jim S. Baca, Corrales, NM (US); David Stanasolovich, Albuquerque, NM (US); Joan M. Tafoya, Penang (MY); Hong Li, El Dorado Hills, CA (US); Tomer Rider, Naahryia (IL)

(72) Inventors: Jim S. Baca, Corrales, NM (US); David Stanasolovich, Albuquerque, NM (US); Joan M. Tafoya, Penang (MY); Hong Li, El Dorado Hills, CA (US); Tomer Rider, Naahryia (IL)

(21) Appl. No.: 13/652,517

(22) Filed: Oct. 16, 2012

(51) Int. Cl. G06N 5/02

(52) U.S. Cl. 706/48; 706/46

(57) ABSTRACT

In accordance with some embodiments of the present invention, information about a user's activities and habits may be collected on an ongoing basis with the user's permission. This information about previous history can then tied to inferences that enable predictions about the user's preferences. As a result, when it comes time for the user to make a decision or a selection, information about past history and permissible inferences can be used to automatically provide suggestions for implementing future activities. In addition, in some cases this previous history information can be used to optimize future selections.

### BACKGROUND

This relates generally to computer controlled devices.

Many people today are constantly in possession of computer devices and particularly cellular telephones with processor based capabilities. These devices include information gathering tools that collect information about the user's activities in terms of telephone calls, global positioning system coordinates, web page browsing, on-line and non-online purchases and other computer activities.

Thus these personal computing devices have a wealth of information that can be applied to a variety of different applications. For example, devices that track a user's whereabouts are known. Other users can remotely log into a web page that allows a user with access privileges to know where another user currently is located. These systems use global positioning coordinates that are collected on an ongoing basis to track the user's position.

### BRIEF DESCRIPTION OF THE DRAWINGS

Some embodiments are described with respect to the following figures:

FIG. 1 is a flow chart for one embodiment to the present invention;

FIG. 2 is a flow chart for a more specific embodiment to the present invention; and

FIG. 3 is a hardware depiction for one embodiment to the present invention.

### DETAILED DESCRIPTION

In accordance with some embodiments of the present invention, electronic information about a user's activities and habits may be collected on an ongoing basis with the user's permission. This electronic information about previous history can then be tied to inferences that enable electronic predictions about the user's preferences. As a result, when it comes time for the user to make a decision or a selection, information about past history and permissible inferences can be used to automatically provide suggestions for implementing future activities. In addition, in some cases this previous history information can be used to optimize future selections.

In some embodiments, the selection tool may be implemented in a personal computing device that is typically carried with the user. While any mobile computing device can be used for this purpose, it is particularly advantageous in connection with very compact devices such as cellular telephones, tablets, mobile Internet devices, and relatively small laptop computers.

In some embodiments, the mobile device may keep track of the places a particular user goes. Then it may correlate these locations with information about the nature of the facility at that location. For example, the name of a store may be derived using computer lookup of an address or location. Information about when the user visits a particular location and characteristics of the location can be used to determine that the location is the user's workplace or the user's home. For example, if the user is generally at a given location from 9 a.m. to 5 p.m., this would suggest that it is the user's workplace, whereas if the user is typically there from 7 p.m. to 5 a.m. this would suggest the location is the user's home. Based on the locations that the user visits, the frequency of the visit, and the times when the user visits these locations, information can be inferred about a user's preferences.

For example if a user repeatedly goes to a variety of different family-style Italian restaurants, an inference can be derived that the user likes family-style Italian restaurants. Then, when the user is in a new location, and is looking for a restaurant, the computer could suggest a proximate family-style Italian restaurant. It knows that a given restaurant that the user has visited in the past is a family-style Italian restaurant by consulting a database correlating locations or addresses with the type of business or the nature of the services provided. The same kind of database can be used, in the new locale, to find a restaurant that provides a desired service.

The following examples illustrate two possible use cases:

### Use Case #1

The user opts-in to the personal travel preference learning platform. It begins to track and learn the user's travel preferences including work location, working timing and duration, gym membership, restaurants frequented, shopping preferences, friends visited, etc. The platform deduces that the user works from 7:30 a.m. to approximately 6:00 p.m., Monday through Friday at 4110 Sara Road, Rio Rancho, N. Mex. This is an Intel facility so the conclusion is that the user works at this Intel facility. The user drives to a Defined Fitness center at 5:00 a.m. to 6:00 a.m., Monday through Saturday. The user visits a number of different restaurants on Friday night with an Italian restaurant being the most prevalent. The user also frequents several local book stores, so the platform logic deduces that she is very interested in books or reading. On a business trip to Hudson, Mass. the user's smartphone accesses the personal travel platform to see her preferences, and then applies them to the new location, Hudson, Mass. The personal travel platform maps the location of the Intel facility, an Italian restaurant, several book stores, and a fitness center. The businesses that these locations represent are presented as a series of icons which the user can select and be guided to the location via GPS.

### Personal Travel Profile—Home Location Cumulative Actuals

| Latitude/Long | Function | Name | Avg. Timing | Days | Prob. |
|---|---|---|---|---|---|
| 35.231322/−106.656684 | Work | Intel | 7:30 a.m.-6:00 p.m. | M-F | 97.2% |
| 35.130589/−106.518478 | Book | Page | No Pattern | Sat | 42.4% |
| | store | One | | | |
| 35.079864/−106.605654 | Italian | Scalos | 6:30 p.m. | Fri. | 71.8% |
| | Rest. | | | | |
| 35.250623/−106.653742 | Gym | Defined | 5:00 a.m.-6:00 a.m. | M-Sat | 96% |
| | | Fitness | | | |
| 35.285645/−106.600082 | Home | Home | 6:30 p.m.-4:45 a.m. | M-F | 98.6% |
| 35.138387/106.601154 | Movies | Century | 12:00 p.m.-3:00 p.m. | Sat. | 84.7% |
| | | 24 | | | |
| 35.193610/−106.656639 | Shopping | Walmart | 7:00 a.m.-8:00 a.m. | Sun. | 81.9% |

### Personal Travel Profile—Applied to Visiting Location: Hudson, Mass.

| | | |
|---|---|---|
| 42.379779/71.557285 | Work | Intel |
| 42.371208/71.236943 | Book store | Back Pages |
| 42.391323/71.565071 | Italian restaurant | Sofia Ristorante |
| 42.392430/−71.558148 | Gym | Paradise Gym |
| 42.396771/−71.592597 | Hotel | Holiday Inn |
| 42.354819/−71.611451 | Movies | Solomon Pond |

### Use Case #2

Use Case 2 starts with Use Case 1 above. The user opts-in to the personal travel preference learning platform, with the enhanced contextual data option, which is collected through context as a service (CaaS) providers. In this use case, the users travel activities are tracked as in use case #1. In addition, purchases at retail outlets, driving patterns (highway, side streets, alternative travel times, etc.). The data is collected through established channels such as buying histories, smartphone tracking vs. time and daily traffic patterns. The added information is integrated with the information collected through the platform to form an increasingly rich picture of a user's life patterns. When the user visits a new location, the personal travel platform utilizes the user preferences to map a potential travel experience for the new location. The platform taps into the local traffic density on surrounding roads vs. time, and provides a recommended departure time and route (within user configured guidelines) to go from the hotel to the work location and other preferred stops. For this user's preferences and the hotel and work locations, the recommended departure time is 7:15 a.m. along a specific route using several side roads. In this case, the personal travel platform delivers a travel option with incentives for the new location. Through the platform, these businesses in the new city offer significant discounts for the user to visit a combination of the businesses using the personal travel platform. For example, this particular user obtains a 40% off coupon if she visits the Sofia Ristorante Italian restaurant and Back Pages book store in Hudson, Mass. within the next 24 hours.

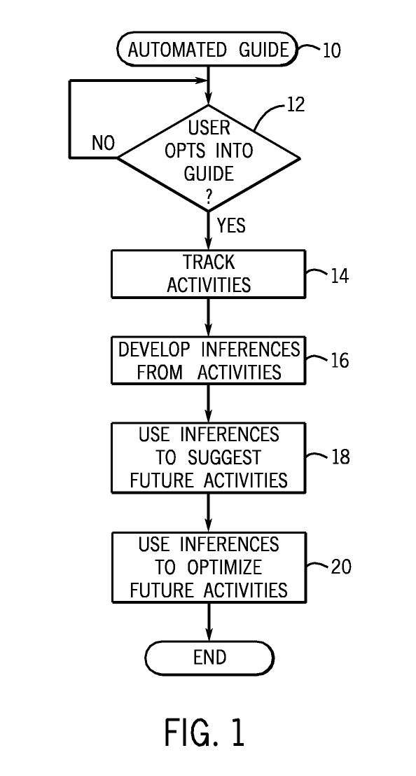

Referring to FIG. 1, an automated guide 10 may be implemented in software, firmware and/or hardware. In software and firmware embodiments it may be implemented by computer executed instructions stored in one or more non-transitory computer readable media such as an optical, magnetic or semiconductor storage.

The automated guide sequence 10 may begin by determining whether the user wants to opt into the guide function as indicated in diamond 12. This allows the user to avoid wasted battery power and computer time performing analyses that the user does not desire to use. If the user opts into the guide, the guide may track various activities of the user as indicated in block 14. These activities can include the user's routes of travel using global positioning system coordinates, purchases that the user makes either online or using a handheld device to scan a QR code, software that the user uses on the computer, websites that the user views, television shows that the user views, photographs that the user takes and likes and dislikes commonly associated with some social networking sites such as Facebook.

Once the activities have been developed and logged, the frequency and the times when these activities are done may also be recorded. The frequency characteristics of the activities, their locations, and time when the locations were visited may be used to develop inferences from those activities, as indicated in block 16. Then the inferences may be used to suggest future activities to the user as indicated in block 18. Thus, in the example given above, when the user wants to find a restaurant to go to, the computer may realize that the user likes family-style Italian restaurants and may search a database to find a proximate restaurant offering that style of food.

In addition, in some embodiments, the inferences may be used to optimize future activities as indicated in block 20. For example if the user is travelling on a course that the user commonly travels to go to work, but the system knows that that conventional route of travel would encounter delays because of traffic reports that are available online, the computer can suggest an alternative. In this case, it may know alternative routes the user has taken in the past or could take and may suggest those alternate routes. In such cases, the user's nature and habits may be used to optimize future activities.

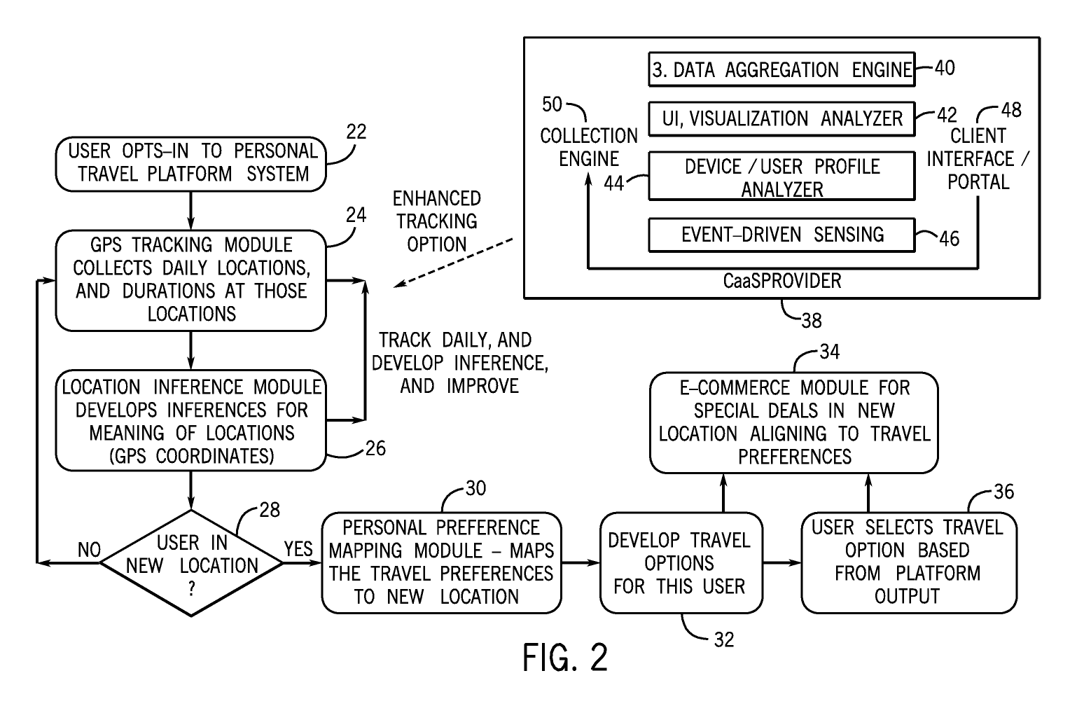

In connection with a particular example, the system may be used for making selections in the course of travelling. Thus referring to FIG. 2, a sequence may be implemented in software, firmware and/or hardware. The sequence may be implemented using computer executed instructions stored in one or more non-transitory computer readable media.

The sequence may begin by determining whether the user opts into a personal travel platform system as indicated in block 22. If so, a global positioning system (GPS) tracking module collects daily locations and durations at those locations as indicated in block 24. Then a location inference module develops inferences from locations identified by GPS coordinates and other collected data as indicated in block 26. In other words, as indicated in FIG. 2, activities may be tracked on a daily basis to develop inferences and to improve daily activities. In addition, an enhanced tracking option 38 may include a data aggregation engine 40, user interface with visualization analyzer 42, a device/user profile analyzer 44 and an event driven sensing unit 46. A collection engine 50 and client interface/portal 48 may be used as well. In some embodiments a content as a service (CaaS) may be offered by providers on a pay-as-you-go or on an advertising supported basis.

In such cases an enhanced tracking option may be provided by a service provider as opposed to simply using local software onboard a particular processor-based device.

Then a check at diamond 28 indicates whether the user is detected to be in a new location. This may be again determined by a global positioning system tracking. If not a new location, the flow returns to continue to collect information about habits. If the user is in a new location, a personal preference module maps the travel preferences to the new location as indicated in block 30. Then new travel options may be generated for this user as indicated in block 32. An e-commerce module may search for the special deals or services a new location, aligning to those travel preferences, at 34. Then at block 36, the user selects travel options based on platform outputs.

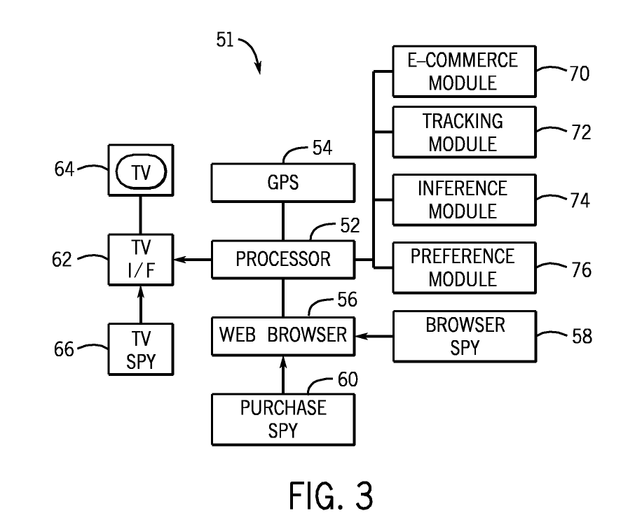

Referring to FIG. 3, a typical portable computer 51 that is useful in the present application may include a processor 52 together with a global positioning system module 54. A web browser 56 may be coupled to the processor. The web browser may include a browser spy 58 that snoops browser activities. A purchaser spy 60 may identify web purchases, for example, by snooping the use of a credit card. Alternatively non-online purchases made using QR codes displayed on a cellular telephone may be logged as well, including purchase location, object purchased and price. A television (T.V.) interface 62 may in turn be coupled to a television 64. A T.V. spy 66 coupled to the television interface 62 may monitor what shows are watched at which time in order to develop a history of user activities.

In some embodiments, additional software, firmware or hardware modules such as an e-commerce module 70, tracking module 72, inference module 74 and a preference module 76 may be provided. These modules may be implemented by a storage device in some embodiments.

In many cases, the inferences may be rules that are developed and stored in an appropriate inference module. For example, a given system may determine when a given global positioning system coordinate is found to correlate through a database with the name of a facility or business located at that particular location. In addition inferences may be drawn about the times that a user goes to a specific location with regard to how the location relates to the user. For example, the user's home and workplace can be derived in this way. Similarly, databases may provide information about particular locations. These modules may be implemented by a storage device in some embodiments.

For example, using the example above, databases may provide information that a given address is associated with an Italian restaurant of a given name and that that restaurant specializes in a particular type of food from which the system can derive information that may ultimately suggest that the user likes that particular type of food.

Likewise information about television programs that the viewer watched may be correlated through the inference engine to determine information about the type of television program watched. This type of information can then be used over time to develop a sense that a particular user likes a particular type of show. Then when the user wants to watch a new show, the television guide can be searched to find shows of that type currently available.

### Additional Notes and Examples

One example embodiment may be a method comprising compiling a history of user's travels on a computer that accompanies the user, deriving inferences from said history, using said computer, and using those inferences to suggest, using said computer, an activity at a new location visited by the user. The method may include using said inferences to optimize a future activity. The method may include using said inferences to make a selection for the user while travelling. The method may include compiling a history includes compiling information about locations visited. The method may include compiling a history includes compiling information about how often a location is visited. The method may include compiling a history includes collecting information about a time when the user visits a location. The method may include compiling a history includes recording the amount of time a user spends at a location. The method may include compiling a history includes compiling information about web sites visited. The method may include compiling a history includes compiling information about electronic purchases. The method may include compiling information about television show viewing.

Another example embodiment may be one or more non-transitory computer readable media storing instructions executed by a computer to develop a history of travels, analyze said history to determine a pattern; and use said pattern to suggest an activity in a new location. The media may further store instructions to use said inferences to optimize a future activity. The media may further store instructions to use said pattern to make a selection for the user while travelling. The media may further store instructions to compile a history includes compiling information about locations visited. The media may further store instructions to compile a history includes compiling information about how often a location is visited. The media may further store instructions to develop a history by collecting information about a time when the user visits a location. The media may further store instructions to record the amount of time a user spends at a location. The media may further store instructions to compile information about web sites visited. The media may further store instructions to compile information about electronic purchases. The media may further store instructions to compile information about television show viewing.

And yet another example embodiment may be a computer comprising a processor to compile a history of electronic activities on a computer, derive inferences from patterns of said activities, use those inferences to suggest a future activity, and a storage coupled to said processor. A computer may include said processor to use said inferences to optimize a future activity. A computer may include said processor to use said inferences to make a selection for the user while travelling. The computer may include said processor to compile a history by compiling information about locations visited. The computer may include said processor to compile a history by compiling information about how often a location is visited.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
compiling a history of user's travels on a computer that accompanies the user;
deriving inferences from said history, using said computer; and
using those inferences to suggest, using said computer, an activity at a new location visited by the user.

2. The method of claim 1 including using said inferences to optimize a future activity.

3. The method of claim 1 including using said inferences to make a selection for the user while travelling.

4. The method of claim 1 wherein compiling a history includes compiling information about locations visited.

5. The method of claim 1 wherein compiling a history includes compiling information about how often a location is visited.

6. The method of claim 1 wherein compiling a history includes collecting information about a time when the user visits a location.

7. The method of claim 1 wherein compiling a history includes recording the amount of time a user spends at a location.

8. The method of claim 1 wherein compiling a history includes compiling information about web sites visited.

9. The method of claim 1 wherein compiling a history includes compiling information about electronic purchases.

10. The method of claim 1 including compiling information about television show viewing.

11. One or more non-transitory computer readable media storing instructions executed by a computer to:
develop a history of travels;
analyze said history to determine a pattern; and
use said pattern to suggest an activity in a new location.

12. The media of claim 11 further storing instructions to use said inferences to optimize a future activity.

13. The media of claim 11 further storing instructions to use said pattern to make a selection for the user while travelling.

14. The media of claim 11 further storing instructions to compile a history includes compiling information about locations visited.

15. The media of claim 11 further storing instructions to compile a history includes compiling information about how often a location is visited.

16. The media of claim 11 further storing instructions to develop a history by collecting information about a time when the user visits a location.

17. The media of claim 11 further storing instructions to record the amount of time a user spends at a location.

18. The media of claim 11 further storing instructions to compile information about web sites visited.

19. The media of claim 11 further storing instructions to compile information about electronic purchases.

20. The media of claim 11 further storing instructions to compile information about television show viewing.

21. A computer comprising:
a processor to compile a history of electronic activities on a computer, derive inferences from patterns of said activities, use those inferences to suggest a future activity; and
a storage coupled to said processor.

22. The computer of claim 21, said processor to use said inferences to optimize a future activity.

23. The computer of claim 21, said processor to use said inferences to make a selection for the user while travelling.

24. The computer of claim 21, said processor to compile a history by compiling information about locations visited.

25. The computer of claim 21, said processor to compile a history by compiling information about how often a location is visited.
